(19) United States
(12) Patent Application Publication
(10) Pub. No.: US 2025/0139888 A1
(43) Pub. Date: May 1, 2025

(54) THREE DIMENSION MEDIA GENERATION

(71) Applicant: Shutterstock, Inc., New York, NY (US)

(72) Inventor: Dade Orgeron, Mandeville, LA (US)

(21) Appl. No.: 18/927,654

(22) Filed: Oct. 25, 2024

Related U.S. Application Data
(60) Provisional application No. 63/546,151, filed on Oct. 27, 2023.

(51) Int. Cl. G06T 17/00

(52) U.S. Cl. CPC G06T 17/00

(57) ABSTRACT

Methods, systems, and storage media for generating an augment scene space comprising a plurality of scene elements derive from an initial text input. In an exemplary method, the disclosure comprises receiving a text input at a processor. The method include determining a plurality of scene elements associated with the text input. The scene element is correlated to a scene element identifier based on the text input. The method further includes generating, by a model generator, a scene element from the plurality of scene elements for display. The method also includes generating a scene space for display comprising the plurality of scene elements in a display surface.

### CROSS-REFERENCE TO RELATED APPLICATIONS

The present disclosure is related and claims priority under 35 U.S.C. 119 (e) to U.S. Provisional Patent Application No. 63/546,151 filed on Oct. 27, 2023, the disclosure of which is hereby incorporated by reference in its entirety for all purposes.

### TECHNICAL FIELD

The present disclosure generally relates to editing visual media and, more particularly, implementing models to edit visual media.

### BACKGROUND

There is inherent complexity in generating visual media in a three-dimensional (3D) space. Further, there are limitations in the inputs that can be used to generate the media, which can require artistic skill to produce the desired visual result. The difficulty can be further augmented by the level of detail sought in a three-dimensional scene.

### BRIEF SUMMARY

The subject disclosure provides modeling a plurality of objects in a 3D space of a visual display and orienting those objects based on initially received test input. The overall display can be refined based on data received from a training model.

One aspect of the present disclosure relates to a method for 3D media generation. In an exemplary method, the disclosure comprises receiving a text input at a processor. The method includes determining a plurality of scene elements associated with the text input. The scene element is correlated to a scene element identifier based on the text input. The method further includes generating, by model a generator, a scene element from the plurality of scene elements for display. The method also includes generating a scene space for display comprising the plurality of scene elements in a display surface.

Another aspect of the present disclosure relates to a system configured for 3D media generation. The system may include one or more hardware processors configured by machine-readable instructions to generate the 3D media. The processor(s) may be configured to receive a text input at a processor. The instructions may determine a plurality of scene elements associated with the text input. The scene element is correlated to a scene element identifier based on the text input. The instructions may be configured to generate, by a model generator, a scene element from the plurality of scene elements for display. The instructions also include generating a scene space for display comprising the plurality of scene elements in a display surface.

Yet another aspect of the present disclosure relates to a non-transient computer-readable storage medium having instructions embodied thereon, the instructions being executable by one or more processors to perform a method for three-dimensional media generation. The method comprises receiving a text input at a processor. The method includes determining a plurality of scene elements associated with the text input. The scene element is correlated to a scene element identifier based on the text input. The method further includes generating, by a model generator, a scene element from the plurality of scene elements for display. The method also includes generating a scene space for display comprising the plurality of scene elements in a display surface.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an example computer system (e.g., representing both client and server) with which aspects of the subject technology can be implemented.

FIG. 2 illustrates a block diagram for modeling a scene for display.

FIG. 3 illustrates a system configured for modeling a scene space for display, in accordance with one or more implementations.

FIG. 4 illustrates an example flow diagram for modeling a scene space for display, according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The current disclosure is directed to resolve the technical problem of generating a scene including a plurality of three-dimensional models in a single display. In particular, hardware system capabilities and functionalities can take time and effort to generate a model of an object for display. For example, when a user desires to generate a cityscape, a resultant three-dimensional (3D) view of the cityscape is taxing on the memory capacity and server processing speed due to processing elements required to generate the model. As a solution, the disclosure utilizes a plurality of model generators for each object in the scene space (cityscape) and an aggregator model generator working in conjunction with the other model generators to expedite processing of a scene space.

In a further aspect, the disclosure includes aspects of automation by incorporating artificial intelligence (AI) and machine learning (ML) tools to aid in customizing the scene space for display. There is widespread use and availability of machine learning, artificial intelligence, and like tools that can automatically generate desirable multimedia content based on selected keywords, themes, and other semantic concepts associated with a product. The aggregate model generator capabilities can boost brainstorming and refinement processes once a new scene space is developed. In a further aspect, collaboration between a team of creators can be introduced, tried, updated, or modified quickly to generate a scene space.

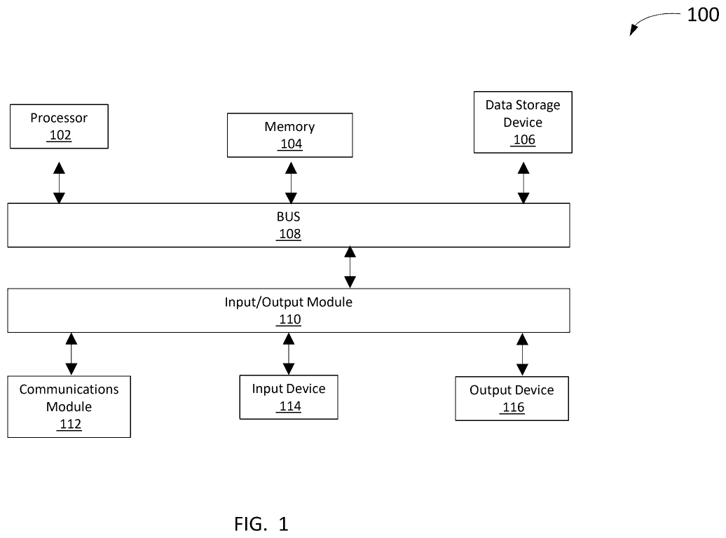

FIG. 1 is a block diagram illustrating an exemplary computer system 100 with which aspects of the subject technology can be implemented. In certain aspects, the computer system 100 may be implemented using hardware or a combination of software and hardware, either in a dedicated server, integrated into another entity, or distributed across multiple entities.

Computer system 100 (e.g., server and/or client) includes a bus 108 or other communication mechanism for communicating information, and a processor 102 coupled with bus 108 for processing information. By way of example, the computer system 100 may be implemented with one or more processors 102. Processor 102 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 100 can include, in addition to hardware, code that creates an execution environment for the computer program in question, e.g., code that constitutes processor firmware, a protocol stack, a database management system, an operating system, or a combination of one or more of them stored in an included memory 104, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 108 for storing information and instructions to be executed by processor 102. The processor 102 and the memory 104 can be supplemented by, or incorporated in, special purpose logic circuitry.

The instructions may be stored in the memory 104 and implemented in one or more computer program products, i.e., one or more modules of computer program instructions encoded on a computer-readable medium for execution by, or to control the operation of, the computer system 100, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 104 may also be used for storing temporary variable or other intermediate information during execution of instructions to be executed by processor 102.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 100 further includes a data storage device 106 such as a magnetic disk or optical disk, coupled to bus 108 for storing information and instructions. Computer system 100 may be coupled via input/output module 110 to various devices. The input/output module 110 can be any input/output module. Exemplary input/output modules 110 include data ports such as USB ports. The input/output module 110 is configured to connect to a communications module 112. Exemplary communications modules 112 include networking interface cards, such as Ethernet cards and modems. In certain aspects, the input/output module 110 is configured to connect to a plurality of devices, such as an input device 114 and/or an output device 116. Exemplary input devices 114 include a keyboard and a pointing device, e.g., a mouse or a trackball, by which a user can provide input to the computer system 100. Other kinds of input devices 114 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 116 include a graphical user interface (GUI) display devices, such as an LCD (liquid crystal display) monitor, for displaying information to the user.

According to one aspect of the present disclosure, the above-described gaming systems can be implemented using a computer system 100 in response to processor 102 executing one or more sequences of one or more instructions contained in memory 104. Such instructions may be read into memory 104 from another machine-readable medium, such as data storage device 106. Execution of the sequences of instructions contained in the main memory 104 causes processor 102 to perform the process steps described herein. One or more processors in a multi-processing arrangement may also be employed to execute the sequences of instructions contained in memory 104. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 100 can include clients and servers. A client and server are generally remote from each other and typically interact through a communication network. The relationship of client and server arises by virtue of computer programs running on the respective computers and having a client-server relationship to each other. Computer system 100 can be, for example, and without limitation, a desktop computer, laptop computer, or tablet computer. Computer system 100 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 102 for execution. Such a medium may take many forms, including, but not limited to, non-volatile media, volatile media, and transmission media. Non-volatile media include, for example, optical or magnetic disks, such as data storage device 106. Volatile media include dynamic memory, such as memory 104. Transmission media include coaxial cables, copper wire, and fiber optics, including the wires that comprise bus 108. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 100 reads game data and provides a game, information may be read from the game data and stored in a memory device, such as the memory 104. Additionally, data from the memory 104 servers accessed via a network the bus 108, or the data storage 106 may be read and loaded into the memory 104. Although data is described as being found in the memory 104, it will be understood that data does not have to be stored in the memory 104 and may be stored in other memory accessible to the processor 102 or distributed among several media, such as the data storage 106.

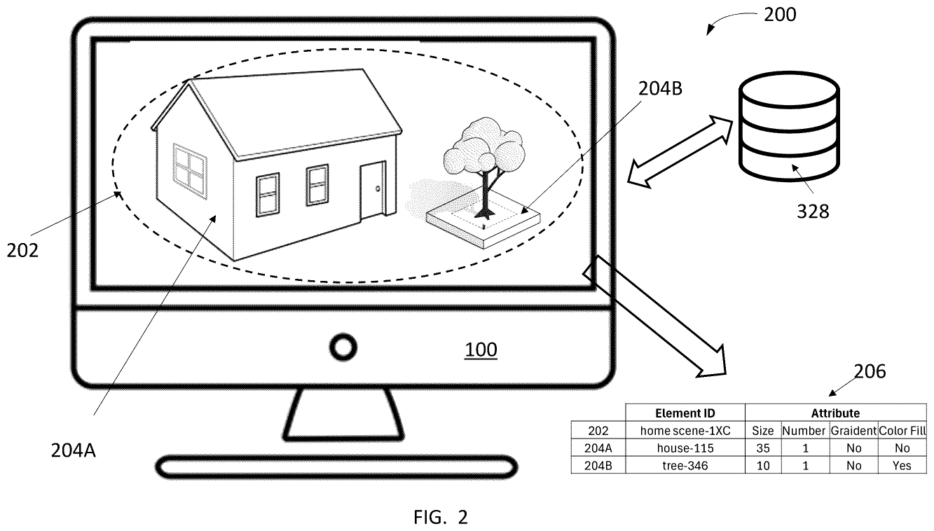

As depicted in FIG. 2, the exemplary system 200 can comprise a computing system 100 in communication with an external source 328 such as a data base. A platform or application can be implemented on the computing system 100 to generate a three-dimensional model of a scene space 202. The scene space 202 can comprise a plurality scene elements 204A/204B. As depicted in the scene space 202, a 3D model scene element of a home 204A and a 3D model scene element of a tree 204B can be spatially oriented in the GUI display of the computing system 100. The scene elements 204A/204B can be introduced to the system 100 when a user provides an input to the processor of the system 100. The system can be configured to parse the text input and determine which scene elements 204A/204B can be introduced to the scene space 202. When determining scene elements, a scene element identifier can be generated and associated with the parsed text input. The scene element identifier can comprise a common name associated with a scene element such as a house or tree. In another aspect, the scene element identifier can be an alphanumeric label or metatag.

In one aspect, the computing system can generate the 3D model of a scene element 204 by accessing a previously trained model. In another aspect, the scene element identifier can be used to search a storage device of the computing system 100 or the external resource 328 and import this acquired model into the scene space 202. In conjunction with the model generator associated with each scene element, a model aggregator can be implemented to generate a 3D scene space that spatially orients the scene elements, for example placing the tree to the right of the house as depicted in FIG. 2. Further, the attributes table 206 of the visual display in the scene space 202 can be edited. The attribute editing can be manual, and in the alternative, the attributes associated with the scene space 202 and the scene elements can be edited based on suggestions received from the training module.

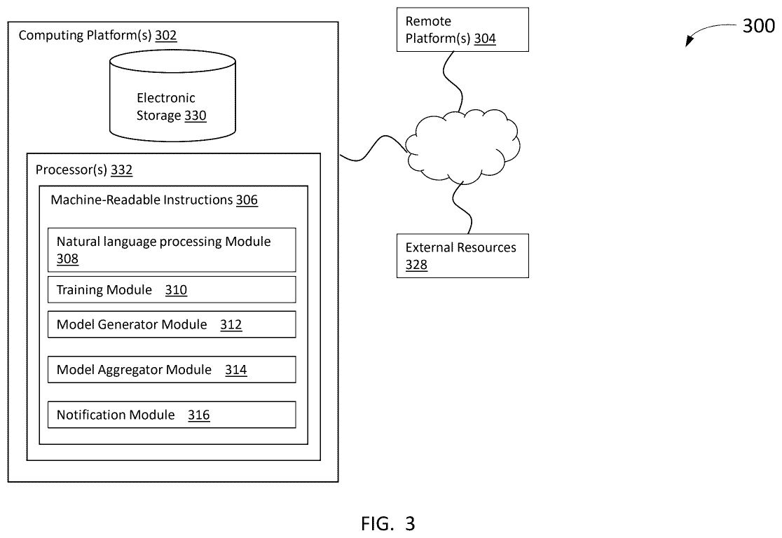

FIG. 3 illustrates a system 300 configured for generating three dimensional models, according to certain aspects of the disclosure. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of natural language processing module 308, training module 310, model generator module 312, model aggregator module 314, notification module 316, and/or other instruction modules.

Natural Language Processing module 308 may be configured to interpret descriptions provided by users to ascertain the type and complexity of the desired scene. The natural language processing module can comprise a large language model. For example, a keyword for a scene element can be identified from metadata associated with the scene element. In a further aspect, the module may implement a thesaurus to identify other model identifiers. For example, the user can provide a text input for a bush to be placed in the scene space; the natural language processing can generate identifiers including, hedge, shrub or topiary, etc.

Training module 310 may be configured to determine the similarities between the text input and identifiers of scene elements stored in databases, such as external resources 328. After parsing any determined identifiers for the Natural language processing module to identify a suitable model for integration into the scene space. The training module may initiate a query for the user to provide additional or supplemental qualifiers to further specify the model of the scene element to be integrated into the scene space. The training module 310 can continuously intake each successive input and use the additional data to refine the model and be stored for subsequent use. In a further aspect, the query can be an adaptive query, wherein the training module offers suggestions in addition to clarifications to ensure a detailed and comprehensive understanding of the user's design.

Model generator module 312 can be used to generate a model of the request scene elements to be placed into the scene space. In another aspect, the identifiers provided from the natural language processing module can access models of the scene element accessible in other libraries/databases. Once identified in the databases, the scene elements can be imported into the scene space and further refined after a supplemental query request. The supplemental query request can include requests to edit attributes of the model such as size, shading, and location in the scene space.

The model aggregator module 314 can be configured to orient the plurality of models in the scene space. The model aggregator module can be configured to determine a spatial arrangement of the scene elements in the scene space on the GUI of the client device. In yet a further aspect, results of the machine learning algorithm can automatically update spatial arrangement and/or size of the scene elements and/or of the scene space. The system can be configured to automatically update the dimensions of the scene space based on spacing limitations of the GUI interactive surface on the respective computing device; memory limitations of the computing device; and/or additional user preference data associated with product item. For example, the size and arrangements of the images in distinct scene elements can change spatial orientation in the display and/or GUI based on the instructions and/or result of the machine learning model. The model aggregator module 314 and the model generator module 312 can operate in conjunction with the training module 310 to further refine scene elements as well as the aggregated scene space.

In a further aspect, the model aggregator module 314 can be configured to generate a bulk amount of scene elements, for example a plurality of trees can be integrated into the scene space of FIG. 2. In a further aspect, a GUI feature such as a drop-down list can appear to prompt a numerical value of scene elements for integration into a scene. In yet another aspect, the model aggregator module can provide a supplemental screen preview to preview potential updates or amendments. In order to provide the preview, the display of the GUI is configured to provide a display arrangement comprising a preview display screen and working display screen. The preview screen can be selectively sized with respect to the scene space. For example, the size of the screen can be automatically determined by the number of scene elements being generated by the model aggregator. In a further aspect, the preview screen can be automatically oriented in a region of the GUI display that has been calculated to have the least obstruction to the other scene elements. The obstruction distance may be determined in pixels of the GUI. In the absence of a preview screen, the display of the aggregated scene elements in the scene space can be configured to display based on a threshold distance determined between scene elements. In a further aspect, the threshold distance may be determined in pixels of the display screen GUI.

The model aggregator module can also implement an attribute randomization feature, wherein the attributes (e.g., size, color, material, opaqueness) of the scene elements can be randomly altered to change the visual representation of the scene element in the visual display.

The notification module 316 can be configured to provide notifications. Various stages of the scene being generated can trigger a notification to be provided. The notifications can be provided to multiple platforms, for example, email, SMS, or in-application alerts.

In some implementations, the modules may be further configured to implement attributes of scene elements or implement scene elements in formats that permit usage and interaction of the scene elements in varied platforms such as gaming, mixed reality, virtual reality and augmented reality. The modules may also be configured to facilitate collaboration between multiple users, and collaborative updates can be received manually from multiple users. In a further aspect, the modules may generate suggestion to alter the attributes of the scene elements or the scene elements themselves.

With respect to collaboration, privacy protocols can be implemented. These privacy settings may be applied to any other suitable computing system. Privacy settings (or “access settings”) for the scene space may be stored in any suitable manner, such as, for example, in association with the project (scene space), in an index on an authorization server, in another suitable manner, or any suitable combination thereof. A privacy setting for the scene space may specify how the scene space (or particular information associated with the scene space) can be accessed, stored, or otherwise used (e.g., viewed, shared, modified, copied, executed, surfaced, or identified) within an application or platform. When privacy settings for a scene space allow a particular user or other entity to access that scene space, the scene space may be described as being “visible” with respect to that user or other entity. In particular embodiments, the system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

In some implementations, computing platform(s) 302, remote platform(s) 304, and/or external resources 328 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 328 may be operatively linked via some other communication media.

A given remote platform 304 may include one or more processors configured to execute computer program modules. The computer program modules may be configured to enable an expert or user associated with the given remote platform 304 to interface with system 300 and/or external resources 328, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 328 may include sources of information outside of system 300, external entities participating with system 300, and/or other resources. In some implementations, some or all of the functionality attributed herein to external resources 328 may be provided by resources included in system 300.

Computing platform(s) 302 may include electronic storage 330, one or more processors 332, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 330 may comprise non-transitory storage media that electronically stores information. The electronic storage media of electronic storage 330 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 330 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 330 may include one or more virtual storage resources (e.g., cloud storage, a virtual private network, and/or other virtual storage resources). Electronic storage 330 may store software algorithms, information determined by processor(s) 332, information received from computing platform(s) 302, information received from remote platform(s) 304, and/or other information that enables computing platform(s) 302 to function as described herein.

Processor(s) 332 may be configured to provide information processing capabilities in computing platform(s) 302. As such, processor(s) 332 may include one or more of a digital processor, an analog processor, a digital circuit designed to process information, an analog circuit designed to process information, a state machine, and/or other mechanisms for electronically processing information. Although processor(s) 332 is shown in FIG. 3 as a single entity, this is for illustrative purposes only. In some implementations, processor(s) 332 may include a plurality of processing units. These processing units may be physically located within the same device, or processor(s) 332 may represent processing functionality of a plurality of devices operating in coordination. Processor(s) 332 may be configured to execute modules 308, 310, 312, 314, and/or 316, and/or other modules. Processor(s) 332 may be configured to execute modules 308, 310, 312, 314, and/or 316, and/or other modules by software; hardware; firmware; some combination of software, hardware, and/or firmware; and/or other mechanisms for configuring processing capabilities on processor(s) 332. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, and/or 316 are illustrated in FIG. 3 as being implemented within a single processing unit, in implementations in which processor(s) 332 includes multiple processing units, one or more of modules 308, 310, 312, 314, and/or 316 may be implemented remotely from the other modules. The description of the functionality provided by the different modules 308, 310, 312, 314, and/or 316 described below is for illustrative purposes, and is not intended to be limiting, as any of modules 308, 310, 312, 314, and/or 316 may provide more or less functionality than is described. For example, one or more of modules 308, 310, 312, 314, and/or 316 may be eliminated, and some or all of its functionality may be provided by other ones of modules 308, 310, 312, 314, and/or 316. As another example, processor(s) 332 may be configured to execute one or more additional modules that may perform some or all of the functionality attributed below to one of modules 308, 310, 312, 314, and/or 316.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

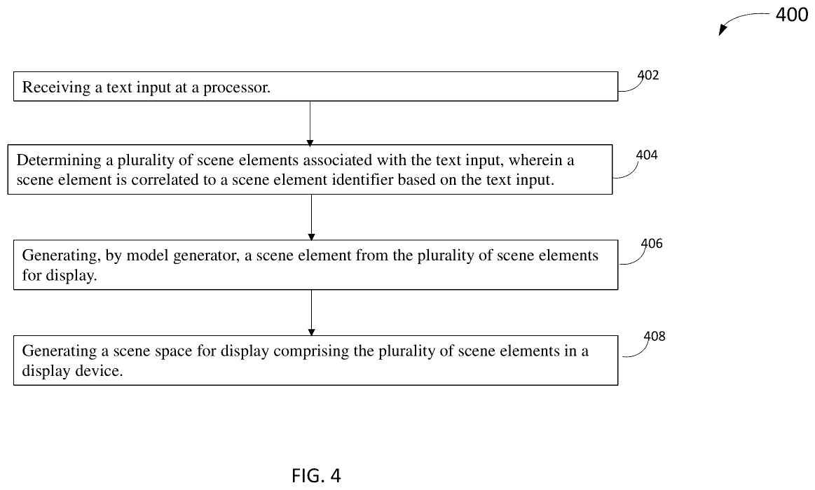

FIG. 4 illustrates an example flow diagram (e.g., process 400) for modeling a scene space for display, according to certain aspects of the disclosure. For explanatory purposes, the example process 400 is described herein with reference to FIGS. 1-3. Further for explanatory purposes, the steps of the example process 400 are described herein as occurring in serial, or linearly. However, multiple instances of the example process 400 may occur in parallel. For purposes of explanation of the subject technology, the process 400 will be discussed in reference to FIGS. 1-3.

At step 402, the process 400 may include receiving text input, at the processor. In a further aspect, the text input can be received via an input device such as a keyboard. In another aspect, the user can provide input via a microphone where in the system is configured to convert audio to text, wherein the text can be parsed. At step 404, the process 400 may include determining a plurality of scene elements associated with the text input, wherein a scene element is correlated to a scene element identifier based on the text input. The received text input from the user to the processor can be parsed into scene element identifiers. For example, the user may provide the phrase, “a three-story home with trees, bushes and a white picket fence”. An exemplary natural language protocol may identify each noun and establish context with the associated adjectives to assign an identifier with each noun-adjective pairing. At step 406, the process 400 may include generating, by a model generator, a scene element from the plurality of scene elements for display. The process may include a model generator wherein the model generator is configured to generate distinct scene elements, for example, three distinct models: 1.) three-story house, 2.) a tree, and 3.) a white picket fence. In a further aspect, these scene elements would be three dimensional when viewed in a display device. At step 408, the process may include generating a scene space for display comprising the plurality of scene elements in a display surface. The scene space can be generated from a supplemental model generator configured to integrate the models of the scene elements into a display view. The scene space comprising the scene elements can be configured to be used in a training model associated with semantic context to the scene elements to spatially orient the scene elements in a display view of the graphical user interface. For example, the white picket fence would be sized and oriented to circumscribe the three-story home.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for modeling a scene space for display, the method comprising:
receiving a text input at a processor;
determining a plurality of scene elements associated with the text input, wherein a scene element is correlated to a scene element identifier based on the text input;
generating, by a model generator, a scene element from the plurality of scene elements for display; and
generating a scene space for display comprising the plurality of scene elements in a display device.

2. The method of claim 1, wherein generating the scene element from the plurality of scene elements comprises receiving the scene element from a storage device associated with the scene element using the scene element identifier.

3. The method of claim 1, wherein determining the plurality of scene elements comprises parsing the text inputs into at least one scene element identifier by implementing a natural language protocol.

4. The method of claim 1, further comprising receiving a supplemental query, and
in response to the supplemental query, updating the scene element of the plurality of scene elements consistent with the supplemental query.

5. The method of claim 1, further comprising providing a notification associated with completing a portion of the scene space.

6. The method of claim 1 wherein the scene space and plurality of scene elements are three-dimensional in a display surface of the display device.

7. The method of claim 1, further comprising initiating a privacy protocol associated with limiting access capabilities for multiple users.

8. A system for modeling a scene space for display, the system comprising:
one or more hardware processors configured by machine-readable instructions to: receive a text input at a processor;
determine a plurality of scene elements associated with the text input, wherein a scene element is correlated to a scene element identifier based on the text input;
generate, by model generator, a scene element from the plurality of scene elements for display; and
generate a scene space for display comprising the plurality of scene elements in a display device.

9. The system of claim 8, wherein the instructions being configured to generate the scene element from the plurality of scene elements comprises receiving the scene element from a storage device associated with the scene element using the scene element identifier.

10. The system of claim 8, wherein the instructions being configured to determine the plurality of scene elements comprises parsing the text inputs into at least one scene element identifier by implementing a natural language protocol.

11. The system of claim 8, wherein the instructions being further configured to receive a supplemental query, and
in response to the supplemental query, updating the scene element of the plurality of scene elements consistent with the supplemental query.

12. The system of claim 8, wherein the instructions being further configured to provide a notification associated with completing a portion of the scene space.

13. The method of claim 1 wherein the scene space and plurality of scene elements are three dimensional in a display surface of the display device.

14. The system of claim 8, further comprising initiating a privacy protocol associated with limiting access capabilities for multiple users.

15. A non-transient computer-readable storage medium having instructions embodied thereon, the instructions being executable by one or more processors to perform a method for modeling a scene space for display, the method comprising:
receiving a text input at a processor;
determining a plurality of scene elements associated with the text input, wherein a scene element is correlated to a scene element identifier based on the text input;
generating, by a model generator, a scene element from the plurality of scene elements for display; and
generating a scene space for display comprising the plurality of scene elements in a display device.

16. The non-transient computer-readable storage medium of claim 15, wherein generating the scene element from the plurality of scene elements comprises receiving the scene element from a storage device associated with the scene element using the scene element identifier.

17. The non-transient computer-readable storage medium of claim 15, wherein determining the plurality of scene elements comprises parsing the text inputs into at least one scene element identifier by implementing a natural language protocol.

18. The non-transient computer-readable storage medium of claim 15, wherein the method further comprises receiving a supplemental query, and
in response to the supplemental query, updating the scene element of the plurality of scene elements consistent with the supplemental query.

19. The non-transient computer-readable storage medium of claim 15, wherein the method further comprises providing a notification associated with completing a portion of the scene space.

20. The non-transient computer-readable storage medium of claim 15, wherein the method further comprises initiating a privacy protocol associated with limiting access capabilities for multiple users.
